(19) United States
(12) Patent Application Publication
(10) Pub. No.: US 2024/0147441 A1
(43) Pub. Date: May 2, 2024

(54) INTERFERENCE CONTROL SYSTEM, INTERFERENCE CONTROL METHOD, LINK-UP DEVICE AND PROGRAM FOR INTERFERENCE CONTROL FOR WIRELESS COMMUNICATIONS

(71) Applicant: NIPPON TELEGRAPH AND TELEPHONE CORPORATION, Tokyo (JP)

(72) Inventors: Junichi IWATANI, Musashino-shi, Tokyo (JP); Yasuhiko INOUE, Musashino-shi, Tokyo (JP); Yusuke ASAI, Musashino-shi, Tokyo (JP)

(73) Assignee: NIPPON TELEGRAPH AND TELEPHONE CORPORATION, Tokyo (JP)

(21) Appl. No.: 18/278,182

(22) PCT Filed: Mar. 3, 2021
(86) PCT No.: PCT/JP2021/008277

§ 371 Date: Aug. 22, 2023

(51) Int. Cl. H04W 72/0453; H04W 72/541

(52) U.S. Cl. CPC H04W 72/0453; H04W 72/541

(57) ABSTRACT

Provided is an interference control system for wireless communication suitable for limiting the total amount of interference given to an interfered device to be protected by a large number of interfering devices. The system provides a control device disposed in a public network with a resource application based on a message issued regarding use of a radio resource by an interfering device disposed in a carrier network. A response based on a message issued by the control device with respect to the resource application is provided to the interfering device that has issued the resource application. A resource table including information in which availability of frequency in carrier network is estimated is updated on the basis of the resource application and the response. The information in which the availability is estimated and included in the resource table is reflected in the resource application.

### TECHNICAL FIELD

This disclosure relates to an interference control system, an interference control method, a link-up device, and program for interference control for wireless communication, and more particularly, to an interference control system, an interference control method, a link-up device, and program for interference control for wireless communication suitable for limiting the total amount of interference given to another interfered device to be protected by a large number of interfering devices having a wireless communication function.

### BACKGROUND ART

As a technology on the premise of a mixture of an interfered device to be protected and a plurality of interfering devices that emits interference signals, there is known a citizens broadband radio service (CBRS) proposed in the United States. More specifically, the CBRS is a technology of wireless communication having a function of suppressing the total amount of interference with respect to the interfered device when the interfered device and the interfering device use the same frequency band. Non Patent Literature 1 below describes a technical standard related to CBRS.

In the CBRS, each of an interfered device and a plurality of interfering devices (CBSD: citizens broadband radio service device) preregisters their position information in a control device (SAS: spectrum access system) via a network. The position information described above includes information indicating the latitude and the longitude of each of the interfering devices and whether the devices are installed indoors or outdoors.

Each of the interfering devices transmits a usage application of radio resources such as a use frequency and transmission power to the control device. The control device that has received the usage application estimates the total amount of interference given to the interfered device by all the interfering devices. The total amount of interference is calculated from position information registered in advance for each of the interfered device and the interfering device, an antenna gain, transmission power, and the like of each device. Then, the control device determines whether or not the usage application is acceptable depending on whether or not the estimated value of the total amount of interference falls within the allowable value, and returns a result of the determination to the interfering device as a response.

Note that, in the CBRS, the application and the response between the interfering device and the control device may be directly exchanged, or may be exchanged via a link-up device (domain proxy).

### CITATION LIST

### Non Patent Literature

CBRS Baseline Standards, WINNF-TS-0016, CBRS WInnForum Standards, Nov. 25, 2020. https://cbrs.wirelessinnovation.org/release-1-of-the-baseline-standard-specifications

### SUMMARY OF INVENTION

### Technical Problem

In an optical access service provided by a communication carrier, a large number of subscribers use a wireless device such as an access point of a wireless LAN. Similarly to the interfering device in the CBRS, the wireless devices may be an interference source with respect to the interfered device to be protected.

In a case where the CBRS technology is applied to the above optical access service, it is assumed that a control device that controls the total amount of interference is installed outside a network of a communication carrier that provides the service. Then, in a case where the wireless device of the subscriber freely issues a usage application to the control device without any adjustment, a large amount of resources are unfairly allocated to some subscribers, and fairness among the entire subscribers can be impaired. In addition, when the wireless device of the subscriber issues a usage application without grasping the availability of frequency, the application issued to congested frequency is rejected, which can cause a situation in which unnecessary applications and responses frequently occur.

The present disclosure has been made in view of the above problems, and it is a first object to provide an interference control system for wireless communication capable of securing fairness in a network as a whole and suppressing occurrence of unnecessary applications by appropriately adjusting usage applications issued from a plurality of interfering devices belonging to a specific network toward a control device placed outside the network.

In addition, the present disclosure has a second object to provide an interference control method for wireless communication for securing fairness in a network as a whole and suppressing occurrence of unnecessary applications by appropriately adjusting usage applications issued from a plurality of interfering devices belonging to a specific network toward a control device placed outside the network.

In addition, the present disclosure has a third object to provide a link-up device for wireless communication for securing fairness in a network as a whole and suppressing occurrence of unnecessary applications by appropriately adjusting usage applications issued from a plurality of interfering devices belonging to a specific network toward a control device placed outside the network.

In addition, the present disclosure has a fourth object to provide an interference control program for wireless communication for securing fairness in a network as a whole and suppressing occurrence of unnecessary applications by appropriately adjusting usage applications issued from a plurality of interfering devices belonging to a specific network toward a control device placed outside the network.

### Solution to Problem

In order to achieve the above objects, a first aspect is desirably an interference control system for wireless communication, the interference control system including a control device that controls an interference amount given to an interfered device that performs wireless communication by a plurality of interfering devices that performs wireless communication, in which

a link-up device disposed between the interfering device and the control device includes a processor unit and a memory storing a program executed by the processor unit, and

the processor unit executes:

processing of providing a control device disposed in a public network with a resource application based on a message issued regarding use of a radio resource by an interfering device disposed in a carrier network;

processing of providing a response based on a message issued by the control device with respect to the resource application to the interfering device that has issued the resource application;

update processing of updating a resource table including information in which availability of frequency managed by the control device is estimated on the basis of the resource application and the response; and

reflection processing of reflecting the information in which the availability is estimated and included in the resource table in at least one of a subsequent resource application from the interfering device and a subsequent response to the interfering device in a form of at least one of limitation and correction.

In addition, a second aspect is desirably an interference control method for wireless communication, the interference control method using a control device that controls an interference amount given to an interfered device that performs wireless communication by a plurality of interfering devices that performs wireless communication, the interference control method including:

a step of providing a control device disposed in a public network with a resource application based on a message issued regarding use of a radio resource by an interfering device disposed in a carrier network;

a step of providing a response based on a message issued by the control device with respect to the resource application to the interfering device that has issued the resource application;

a step of updating a resource table including information in which availability of frequency managed by the control device is estimated on the basis of the resource application and the response; and

a step of reflecting the information in which the availability is estimated and included in the resource table in at least one of a subsequent resource application from the interfering device and a subsequent response to the interfering device in a form of at least one of limitation and correction.

In addition, a third aspect is desirably a link-up device for wireless communication, the link-up device using a control device that controls an interference amount given to an interfered device that performs wireless communication by a plurality of interfering devices that performs wireless communication, the link-up device including:

a processor unit; and

a memory storing a program executed by the processor unit,

in which

the processor unit executes:

processing of providing a control device disposed in a public network with a resource application based on a message issued regarding use of a radio resource by an interfering device disposed in a carrier network;

processing of providing a response based on a message issued by the control device with respect to the resource application to the interfering device that has issued the resource application;

update processing of updating a resource table including information in which availability of frequency managed by the control device is estimated on the basis of the resource application and the response; and

reflection processing of reflecting the information in which the availability is estimated and included in the resource table in at least one of a subsequent resource application from the interfering device and a subsequent response to the interfering device in a form of at least one of limitation and correction.

In addition, a fourth aspect is desirably an interference control program for wireless communication for implementing the link-up device of the third aspect, the interference control program including a program for causing the processor unit to execute:

processing of providing a control device disposed in a public network with a resource application based on a message issued regarding use of a radio resource by an interfering device disposed in a carrier network;

processing of providing a response based on a message issued by the control device with respect to the resource application to the interfering device that has issued the resource application;

update processing of updating a resource table including information in which availability of frequency managed by the control device is estimated on the basis of the resource application and the response; and

reflection processing of reflecting the information in which the availability is estimated and included in the resource table in at least one of a subsequent resource application from the interfering device and a subsequent response to the interfering device in a form of at least one of limitation and correction.

### Advantageous Effects of Invention

According to the first to fourth aspects, it is possible to ensure fairness in a carrier network and suppress the occurrence of unnecessary applications by appropriately adjusting resource applications issued from a plurality of interfering devices belonging to the carrier network toward a control device placed outside the carrier network.

### BRIEF DESCRIPTION OF DRAWINGS

FIG. 1 is a diagram for describing an outline of an interference control system using CBRS which is a comparative example of a system of a first embodiment of the present disclosure;

FIG. 2 is a diagram for describing an outline of the interference control system of the first embodiment of the present disclosure;

FIG. 3 is a diagram for describing a configuration of an interfering device disposed in a carrier NW in FIG. 2;

FIG. 4 is a diagram for describing a configuration of a link-up device illustrated in FIG. 2;

FIG. 5 is a diagram for describing an outline of an operation of the interference control system according to the present disclosure;

FIG. 6 is a diagram for describing an operation of the interference control system of the first embodiment of the present disclosure;

FIG. 7 is a flowchart for describing a flow of processing executed by a link-up device to return a response with respect to a resource application to an interfering device in the first embodiment of the present disclosure;

FIG. 8 is a diagram illustrating one state of a table updated in the link-up device in the first embodiment of the present disclosure;

FIG. 9 is a flowchart for describing a flow of processing executed by the link-up device to transmit the table to the interfering device in the first embodiment of the present disclosure;

FIG. 10 is a flowchart for describing a flow of processing executed by the interfering device to update the table in the first embodiment of the present disclosure;

FIG. 11 is a flowchart for describing a flow of processing executed by the interfering device to transmit a radio resource application in the first embodiment of the present disclosure;

FIG. 12 is a diagram for describing an operation of an interference control system of a second embodiment of the present disclosure;

FIG. 13 is a flowchart for describing a flow of processing executed by a link-up device to return a response with respect to a resource application to an interfering device in the second embodiment of the present disclosure;

FIG. 14 is a diagram for describing an operation of an interference control system of a third embodiment of the present disclosure;

FIG. 15 is a flowchart for describing a flow of processing executed by a link-up device to return a response with respect to a resource application to an interfering device in the third embodiment of the present disclosure;

FIG. 16 is a diagram for describing group division of interfering devices in a fourth embodiment of the present disclosure;

FIG. 17 is a diagram for describing an operation of an interference control system of the fourth embodiment of the present disclosure;

FIG. 18 is a flowchart for describing a flow of processing executed by a link-up device to return a response with respect to a resource application to an interfering device in the fourth embodiment of the present disclosure;

FIG. 19(A) is a diagram illustrating one state of a table for a region A updated in the link-up device in the fourth embodiment of the present disclosure. FIG. 19(B) is a diagram illustrating one state of a table for a region B updated in the link-up device in the fourth embodiment of the present disclosure;

FIG. 20 is a flowchart for describing a flow of processing executed by the link-up device to transmit a table to an interfering device in the fourth embodiment of the present disclosure;

FIG. 21 is a diagram (part 1) for describing group division of interfering devices in a fifth embodiment of the present disclosure;

FIG. 22 is a diagram (part 2) for describing group division of interfering devices in the fifth embodiment of the present disclosure.

FIG. 23 is a diagram for describing an operation of an interference control system of the fifth embodiment of the present disclosure;

FIG. 24 is a flowchart for describing a flow of processing executed by a link-up device to return a response with respect to a resource application to an interfering device in the fifth embodiment of the present disclosure;

FIG. 25(A) is a diagram illustrating one state of a table for an interfering device A updated in the link-up device in the fifth embodiment of the present disclosure. FIG. 25(B) is a diagram illustrating one state of a table for an interfering device B updated in the link-up device in the fifth embodiment of the present disclosure;

FIG. 26 is a flowchart for describing a flow of processing executed by the link-up device to transmit a table to the interfering device in the fifth embodiment of the present disclosure;

FIG. 27 is a diagram for describing an operation of an interference control system of a sixth embodiment of the present disclosure; and

FIG. 28 is a flowchart for describing a flow of processing executed by a link-up device to transmit a table to an interfering device in the sixth embodiment of the present disclosure.

### DESCRIPTION OF EMBODIMENTS

### First Embodiment

### Comparative Example of First Embodiment

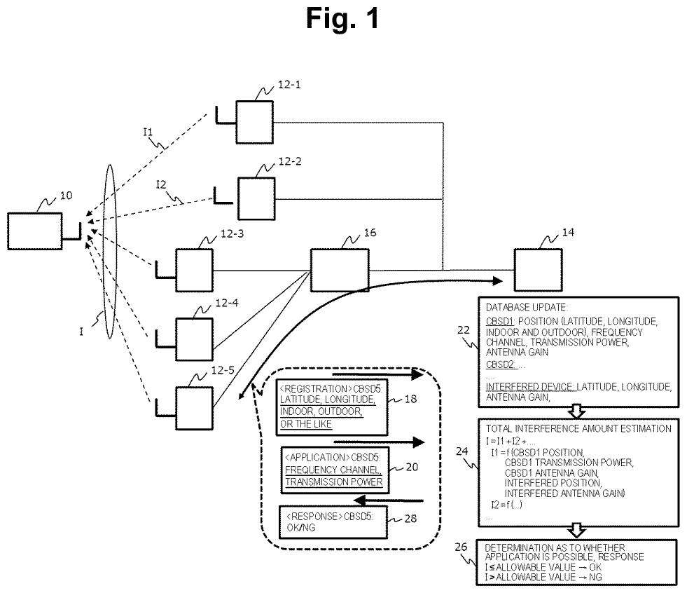

FIG. 1 is a diagram for describing an outline of an interference control system using CBRS. Hereinafter, as a comparative example of the interference control system of the first embodiment of the present disclosure, the configuration and operation of this system will be described.

The system illustrated in FIG. 1 includes an interfered device 10. The interfered device 10 is a wireless device that needs to be protected for communication quality. The system illustrated in FIG. 1 includes a plurality of interfering devices 12-1 to 12-5. Here, five interfering devices are illustrated. In a case where it is not necessary to distinguish the interfering devices 12-1 to 12-5 from each other, they will be hereinafter referred to as interfering devices 12 using reference numeral 12. The interfering device 12 is a wireless device that shares the same frequency band with the interfered device 10.

A radio signal emitted from the interfering device 12 may interfere with a radio signal received by the interfered device 10. In FIG. 1, for example, the interference amount caused by the interfering device 12-1 is represented as “I1”, and the interference amount caused by the interfering device 12-2 is represented as “I2”. In addition, the total amount of interference, which is the sum of interference caused by each interfering device 12, is represented as “I”. In order to protect communication of the interfered device 10, it is necessary to suppress the total interference amount I to an allowable value or less.

In the system illustrated in FIG. 1, some interfering devices 12-1 and 12-2 are directly connected to a control device 14 of the CBRS. In addition, the other interfering devices 12-3 to 12-5 are connected to the control device 14 via a link-up device 16. The link-up device 16 can relay the resource application and the response between each of the plurality of interfering devices 12-3 to 12-5 and the control device 14.

In the system using the CBRS, each of the interfered device 10 and the interfering device 12 preregisters the ID, the position information, and the like of the device in the control device 14 prior to the start of communication. FIG. 1 illustrates a registration message 18 transmitted from the interfering device 12-5 to the control device 14. The registration message 18 specifically includes the information described below.
1. Device ID=CBSD5
2. Latitude and longitude of installation position of the device
3. Information indicating whether the device is installed indoors or outdoors
4. Antenna gain of the device

After the pre-registration described above, each of the interfering devices 12 applies for a communication resource to be used toward the control device 14 when starting communication. FIG. 1 illustrates a state in which a resource application 20 including ID=CBSD5 is issued from the interfering device 12-5 to the control device 14. The resource application 20 specifically includes the information described below.
1. Frequency channel desired to be used for communication
2. Transmission power desired to be used for signal transmission

A database update unit 22 is formed inside the control device 14. The database update unit 22 updates information regarding frequency usage status and the like on the basis of the information obtained by the pre-registration, the information obtained by the resource application, and the information of the response generated for the resource application, and the like. Specifically, when receiving a resource application from a specific interfering device 12, the database update unit 22 updates the database assuming a case where the application is permitted. In addition, when it is determined whether the application is acceptable and a response indicating the result is generated, the database is updated again so that the content of the response is reflected.

A total interference amount estimation unit 24 is formed inside the control device 14. The total interference amount estimation unit 24 calculates the interference amount caused by each interfering device 12, and sets the sum thereof as the total interference amount I. For example, the interference amount I1 caused by the interfering device 12-1 can be calculated by a known method as a function of the position of CBSD1, the transmission power of CBSD1, and the antenna gain of CBSD1, and the position of the interfered device 10, and the antenna gain of the interfered device 10. Then, when a resource application is received from the interfering device 12-1, the interference amount I1 caused when the application is permitted can be estimated by using the transmission power included in the application for the above calculation. When the resource application is not received from the interfering device 12-1, the interference amount I1 is calculated on the basis of the radio resource practically used by the interfering device 12-1. The same applies to the interference amounts 12 to 15 of the other interfering devices 12. The total interference amount I is calculated by taking the sum of the interference amounts I1 to 15 estimated or calculated in this manner.

An acceptability determination/response unit 26 is further formed inside the control device 14. The acceptability determination/response unit 26 determines whether the total interference amount I estimated in response to the resource application issued by any of the interfering devices 12 is equal to or less than an allowable value of interference with respect to the interfered device 10. In a case where the relationship of “total interference amount I allowable value” is established, it can be determined that excessive interference does not occur in the interfered device 10 even when the resource application is permitted. In this case, the acceptability determination/response unit 26 generates an OK response to the resource application. On the other hand, in a case where the relationship of “total interference amount>allowable value” is established, it can be determined that unacceptable interference occurs in the interfered device 10 when the resource application is permitted. In this case, the acceptability determination/response unit 26 generates an NG response to the resource application.

The response generated by the acceptability determination/response unit 26 is transmitted to the interfering device 12 directly or via the link-up device 16. FIG. 1 illustrates a state in which a response 28 is transmitted from the control device 14 to the interfering device 12-5 via the link-up device 16. Here, as illustrated, information of OK or NG is included together with ID=CBSD5.

When receiving an OK response to the resource application, the interfering device 12 starts communication using the frequency and transmission power for which the application is made. On the other hand, when receiving an NG response to the resource application, the resource application is performed again by changing the requested resource. According to the above processing, it is possible to continue to appropriately protect the communication of the interfered device 10 while permitting efficient communication to a large number of the interfering devices 12.

### [Configuration of First Embodiment]

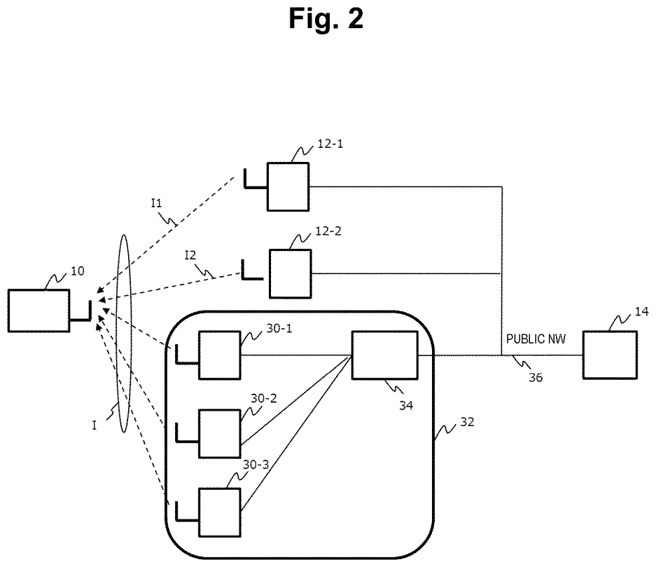

FIG. 2 illustrates a configuration of the interference control system of the first embodiment of the present disclosure. In the interference control system illustrated in FIG. 2, an optical access service provided by a specific communication carrier is incorporated in the configuration of the CBRS illustrated in FIG. 1. Note that, in FIG. 2, the same elements as those illustrated in FIG. 1 are denoted by the same reference numerals, and the description thereof will be omitted or simplified.

The system illustrated in FIG. 2 includes a plurality of interfering devices 30-1 to 30-3 together with interfering devices 12-1 and 12-2. The interfering devices 12-1 and 12-2 are disposed in a public network (NW) 36 together with the control device 14. Hereinafter, in a case where it is not necessary to distinguish the interfering devices 12-1 and 12-2 from each other, they are referred to as “interfering devices 12”.

The interfering devices 30-1 to 30-3 are wireless devices managed by subscribers of optical access services provided by communication carriers. Hereinafter, when it is not necessary to distinguish the interfering devices 30-1 to 30-3 from each other, they are referred to as “interfering devices 30” using reference numeral 30. The interfering device 30 is disposed in a network (hereinafter, referred to as a “carrier NW 32”) managed by a communication carrier. Note that the interfering device 30 is connected to the carrier NW 32 via a subscriber network managed by the subscriber, but here, they are not distinguished and are referred to as a “carrier NW 32”.

In addition, a link-up device 34 is disposed in the carrier NW 32. The link-up device 34 is an element constituting a main part of the interference control system of the present embodiment, and has a function of relaying a resource application and a response between the interfering device 30 and the control device 14.

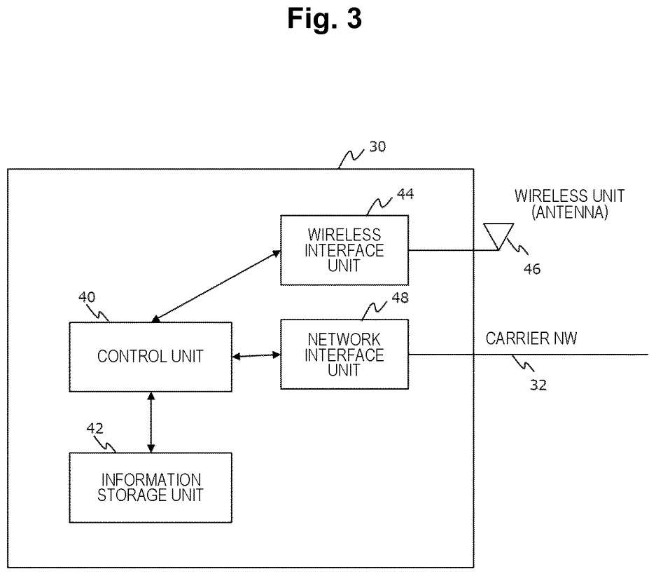

FIG. 3 is a block diagram for describing a configuration of the interfering device 30 illustrated in FIG. 2. As illustrated in FIG. 3, the interfering device 30 includes a control unit 40 and an information storage unit 42. The control unit 40 includes a processor unit (CPU). In addition, the information storage unit 42 includes a memory, and the memory stores a program to be executed by the CPU. The function of the control unit 40 is implemented by the CPU of the control unit 40 proceeding with the processing in accordance with the above-described program. The information storage unit 42 further stores resource information regarding an ID of the device, position information, a frequency used for communication, and the like.

The interfering device 30 includes a wireless interface unit 44. The wireless interface unit 44 can establish wireless communication with an external wireless device via an antenna 46. In addition, the wireless interface unit 44 can acquire GPS information of the device via the antenna 46. The interfering device 30 further includes a network interface unit 48. The network interface unit 48 can transmit and receive messages to and from the link-up device 34 via the carrier NW 32.

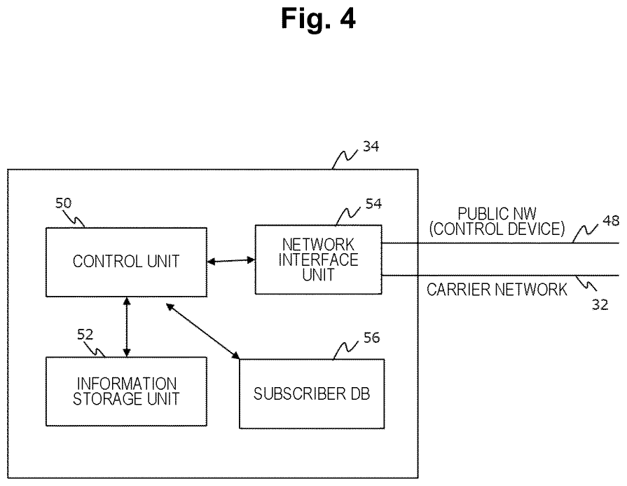

FIG. 4 is a block diagram for describing a configuration of the link-up device 34 illustrated in FIG. 2. As illustrated in FIG. 4, the link-up device 34 includes a control unit 50 and an information storage unit 52. The control unit 50 includes a processor unit (CPU). In addition, the information storage unit 52 includes a memory, and the memory stores a program to be executed by the CPU. The function of the control unit 50 is implemented by the CPU of the control unit 50 proceeding with the processing in accordance with the above-described program. This program can be recorded in a recording medium and provided to the link-up device 34, and can also be provided to the link-up device 34 via a network. The information storage unit 52 further stores information such as content of a message to be relayed and a frequency usage table. As will be described below, the frequency usage table records information of radio resources used by each of the interfering devices 30 and the like.

The link-up device 34 includes a network interface unit 54. The network interface unit 54 can transmit and receive messages to and from each of the interfering devices 30 via the carrier NW 32, and can transmit and receive messages to and from the control device 14 via the public NW 36.

The link-up device 34 further includes a subscriber database (DB) 56. The subscriber DB 56 stores information such as an ID and an address of a subscriber who manages each of the interfering devices 30.

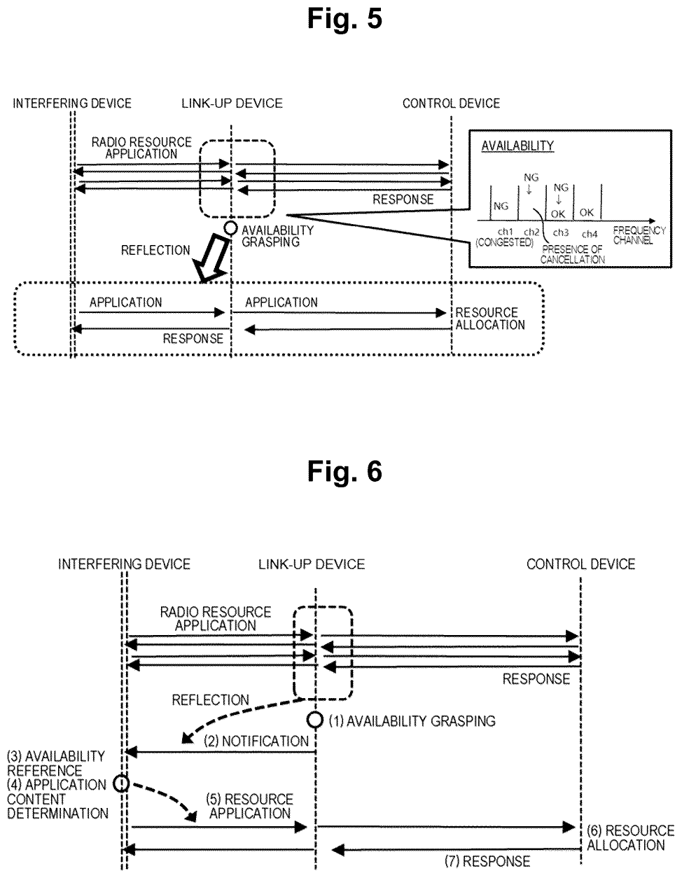

FIG. 5 is a diagram for describing an outline of an operation of the interference control system illustrated in FIG. 2. In the interference control system according to the present disclosure, as in the case of the CBRS illustrated in FIG. 1, each of the interfered device 10 and the interfering devices 12 and 30 preregisters the latitude and the longitude, and the information of indoor installation or outdoor installation in the control device 14. The operation described below occurs after the pre-registration.

The upper part of FIG. 5 illustrates a state in which the resource application issued from the interfering device 30 is transmitted to the control device 14 via the link-up device 34, and the response generated by the control device 14 is sent to the interfering device 30 via the link-up device 34. The link-up device 34 can grasp the availability of the frequency channel in the process of repeating the resource application and response relay between the subordinate interfering device 30 and the control device 14.

For example, the link-up device 34 may receive a resource application for requesting use of a frequency channel ch1 from the interfering device 30-1, and receive an NG response from the control device 14 in response to the application. In this case, the link-up device 34 can recognize that ch1 is in a state that it is congested and unavailable.

In addition, the link-up device 34 may receive, for example, a resource application including cancellation of use of a frequency channel ch2 from the interfering device 30-1. In this case, the link-up device 34 can recognize that ch2 that has not been available until now is in a state that it can be used.

In addition, the link-up device 34 may receive an OK response for ch3 from the control device 14 under a situation where it has been recognized that ch3 cannot be used. In this case, the link-up device 34 can recognize that ch3 has changed from an unavailable state to an available state.

The link-up device 34 grasps the availability of the frequency channel in this manner. Then, when the availability of the frequency channel is known, the resource application and the response can be corrected so that the radio resources are fairly allocated to all the interfering devices 30 using the optical access service. In addition, unnecessary processing can be reduced by avoiding usage application of a congested frequency channel. The lower part of FIG. 5 illustrates a state in which the link-up device 34 reflects the availability of the frequency channel in the resource application or the response in order to implement such a function.

### [Features of First Embodiment]

FIG. 6 is a diagram for specifically describing a flow of processing executed in the present embodiment to implement the functions described above. FIG. 6 illustrates that the processing described below is executed in time series in the interference control system of the present embodiment.
(1) The link-up device 34 grasps the availability of the frequency channel. Specifically, in what situation the frequency channel is used is grasped on the basis of resource application and response messages received in the past. Furthermore, here, from the contents of the resource application and the response received in the past, the status as to which channel and transmission power are used by which interfering device 30 is also grasped.
(2) The link-up device 34 notifies the subordinate interfering device 30 of the grasped availability.
(3) Each of the interfering devices 30 refers to the availability of frequency channel.
(4) Each of the interfering devices 30 determines the content of the resource application on the basis of the referred availability. Thus, unnecessary usage application for a congested frequency channel is avoided. In addition, how another surrounding interfering device 30 uses the frequency may also be considered here. Thus, the resource application is determined so that fair resource allocation is performed. As a result, fairness is ensured for the entire subordinate interfering devices 30.
(5) The interfering device 30 that has determined the content of the application transmits the resource application to the control device 14 via the link-up device 34.
(6) The control device 14 determines whether the resource application is acceptable and determines resource allocation.
(7) The control device 14 returns a response to the interfering device 30 that has issued the resource application via the link-up device 34.

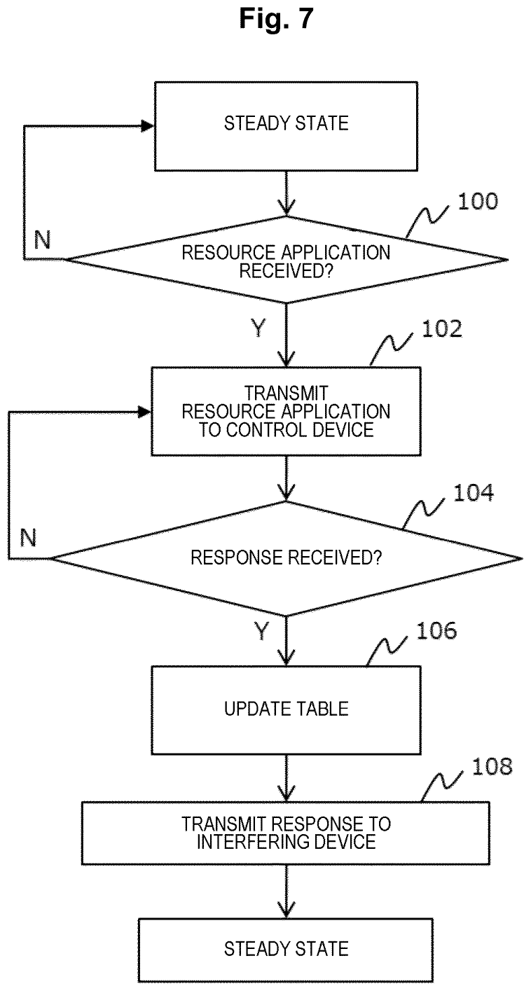

FIG. 7 is a flowchart for describing a flow of processing executed by the link-up device 34 to implement the function (1) above. As illustrated in FIG. 7, the link-up device 34 in the steady state first determines whether a resource application has been received from any of the subordinate interfering devices 30 (step 100).

When the resource application is received from any of the interfering devices 30, the application is transmitted to the control device 14 (step 102).

Next, it is determined whether or not a response to the transmitted resource application has been received from the control device 14 (step 104).

When receiving the response, the link-up device 34 updates the resource table indicating the availability of the frequency channel (step 106). Specifically, the resource table is updated on the basis of the cancellation information included in the resource application received in step 100 above and OK and NG information included in the response received in step 104 above.

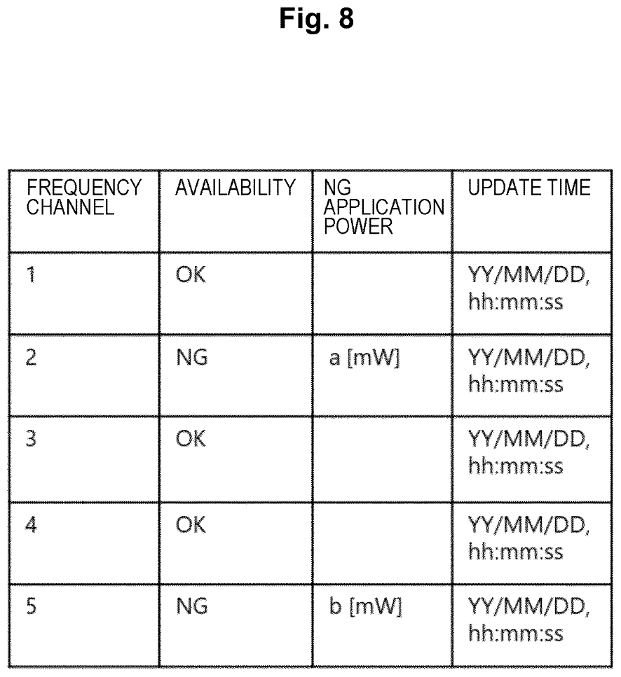

FIG. 8 illustrates one state of the resource table updated by the link-up device 34. As illustrated in FIG. 8, the resource table stores, for example, information described below for each frequency channel.
1. Availability (OK indicates available, NG indicates congested)
2. NG application power (value of transmission power requested by resource application for which NG response has been made)
3. Update time (year/month/day/hour/minute/second)

Furthermore, the resource table may include information regarding a frequency usage status in the surrounding interfering devices 30. For example, when the usage application for ch1 is issued from the interfering device 30-1 and an OK response is returned, it can be determined that the interfering device 30-1 is using ch1. By performing similar processing, the link-up device 34 can estimate the frequency usage status for all the subordinate interfering devices 30. The resource table may include the frequency usage status estimated in this manner.

When the update of the resource table is finished, the link-up device 34 transmits the response received from the control device 14 to the interfering device 30 that has issued the resource application as illustrated in FIG. 7 (step 108). When this processing is finished, the link-up device 34 temporarily returns to the steady state.

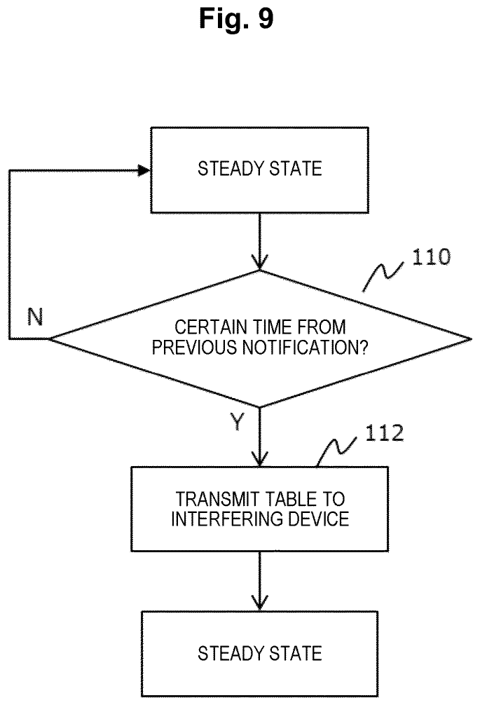

FIG. 9 illustrates the function (2) above, i.e., a flowchart of a routine executed by the link-up device 34 to notify the subordinate interfering devices 30 of the resource table. As illustrated in FIG. 9, the link-up device 34 in the steady state determines whether a certain time has elapsed since the previous notification of the resource table (step 110).

When the elapse of the certain time is recognized, the link-up device 34 simultaneously transmits the information of the latest resource table at that point of time to all the subordinate interfering devices 30 (step 112). When this processing is finished, the link-up device 34 returns back to the steady state.

According to the above processing, the resource table is updated whenever the resource application and the response are exchanged between any one of the interfering devices 30 and the control device 14. Then, every time a certain time elapses, the latest resource table is provided to all the interfering devices 30.

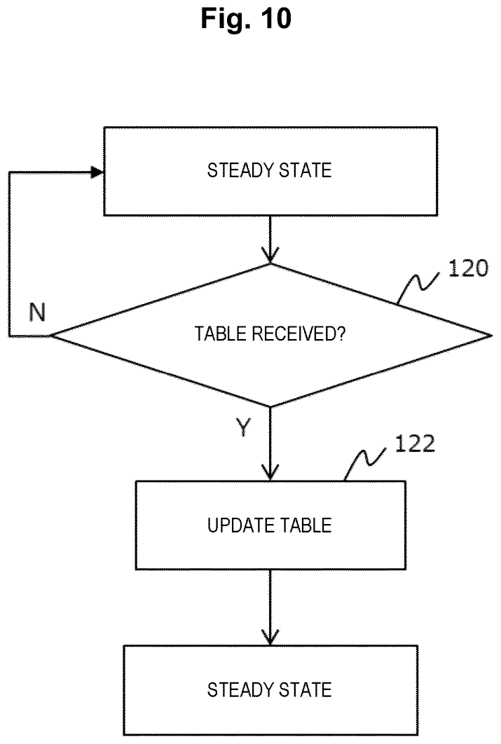

FIG. 10 is a flowchart of a routine executed by the interfering device 30 to update its own resource table. As illustrated in FIG. 10, the interfering device 30 in the steady state determines whether information of the resource table has been received from the link-up device 34 (step 120).

When the reception of the resource table from the link-up device 34 is recognized, the interfering device 30 updates the resource table stored in the information storage unit 42 such that the information of the table is reflected (step 122). Thus, the resource table held by the interfering device 30 is synchronized with the resource table of the link-up device 34.

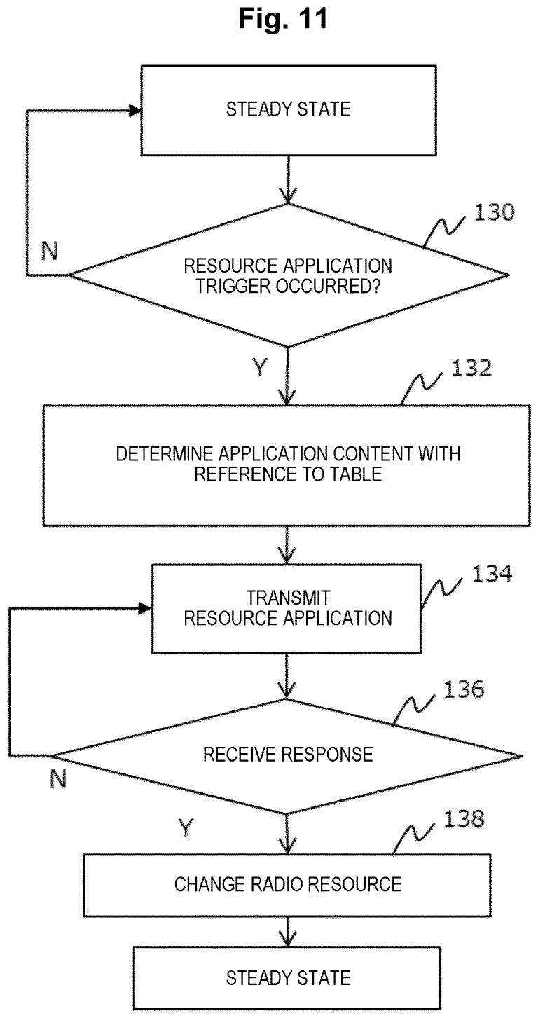

FIG. 11 is a flowchart of a routine executed by the interfering device 30 to determine the content of the resource application with reference to the resource table. As illustrated in FIG. 11, the interfering device 30 in the steady state first determines whether a resource application trigger has occurred (step 130).

When the occurrence of the resource application trigger is recognized, the interfering device 30 first refers to the resource table stored in the information storage unit 42. Next, the content of the resource application is determined on the basis of the situation recorded in the resource table (step 132). For example, when the availability of ch1 is OK and the availability of ch2 is NG, the content of the resource application is determined so as to be given a priority to the usage of ch1.

In addition, in a case where a plurality of frequency channels is available, a channel the update time of which is new is preferentially selected. On the other hand, in a case where all the frequency channels are NG, a channel the update time of which is old is preferentially selected. The availability of frequency changes from moment to moment. Therefore, when the channel is selected as described above, the probability of receiving an OK response can be increased. In addition, when all the channels are NG, a channel having a large application power when it is determined as NG may be prioritized. According to this selection, when the reason for NG is the magnitude of power, an OK response can be received when the application power is small.

When the content of the resource application is determined, the frequency usage status of the surrounding interfering devices 30 is also considered. For example, in a case where the device has already used ch1 and desires to apply for usage of ch3 in addition to ch1, the device checks whether or not at least one frequency channel is allocated to all of the other interfering devices 30 seeking to start communication. As a result, in a case where there is an interfering device 30 that has not received the allocation of even one channel, the usage application for ch3 is skipped. Thus, it is possible to ensure fairness of the entire subscribers. Note that the frequency usage status of the surrounding interfering devices 30 may be included in the resource table described above and provided from the link-up device 34 or may be provided from the link-up device 34 separately from the resource table.

Next, the interfering device 30 that has determined the content of the resource application transmits the resource application (step 134). The resource application transmitted in this manner reaches the control device 14 via the link-up device 34.

The interfering device 30 that has transmitted the resource application waits for a response with respect to the application from the control device 14 (step 136).

Then, the interfering device 30 that has received the response changes the radio resource to be used according to the result of the response (step 138). Specifically, the resource usage status is changed to a state in which the frequency channel for which an OK response has been received is used and the frequency channel for which an NG response has been received is not used. In a case where an NG response has been received for all the frequency channels, the processing of step 130 and subsequent steps is repeated thereafter, so that reapplication is performed with the corrected content.

According to the above processing, in the system in which the plurality of interfering devices 30 belonging to the carrier NW 32 and the interfering devices 12 belonging to the public NW 36 similarly issue resource applications to the control device 14, appropriate adjustment can be performed on the resource applications from the interfering devices 30. In the system of the present embodiment, it is possible to provide a fair service as a whole to a subscriber who uses the carrier NW 32 by this adjustment. In addition, it is possible to provide a highly efficient communication service by suppressing occurrence of unnecessary application.

### Second Embodiment

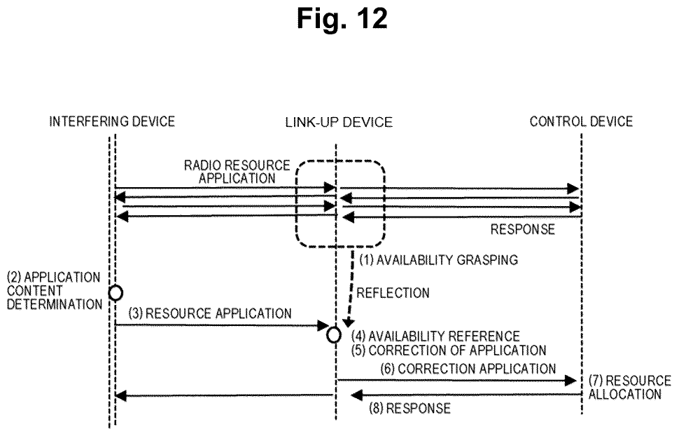

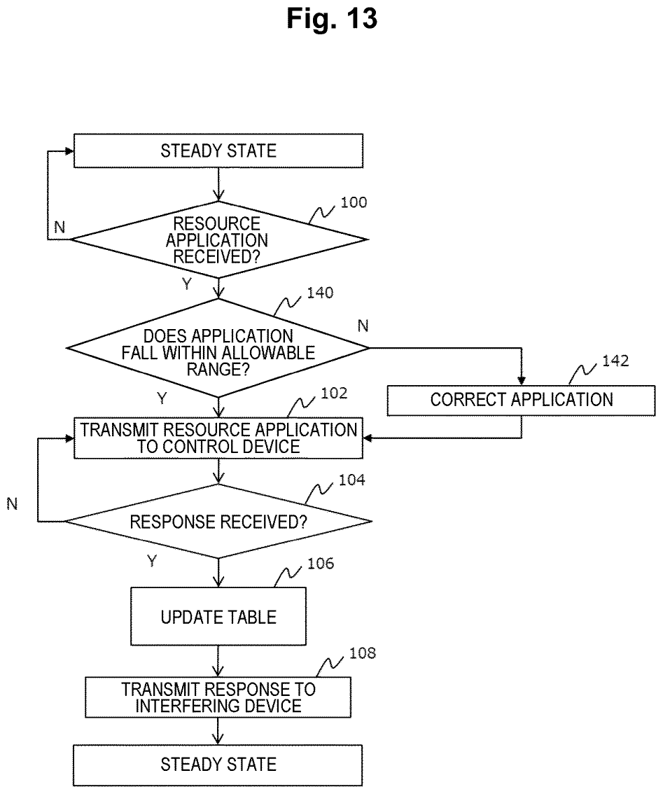

Next, the second embodiment of the present disclosure will be described with reference to FIGS. 12 and 13 together with FIGS. 2 to 5 and 9 to 11. The interference control system of the present embodiment can be implemented by the hardware configuration illustrated in FIGS. 2 to 4 as in the case of the first embodiment. In addition, the interference control system of the present embodiment implements the operation described with reference to FIG. 5 by a specific method different from the case of the first embodiment.

### [Features of Second Embodiment]

FIG. 12 is a diagram for specifically describing a flow of processing executed in the present embodiment in order to reflect the availability of frequency in the resource application. FIG. 12 illustrates that the processing described below is executed in time series in the interference control system of the present embodiment.
(1) The link-up device 34 grasps the availability of the frequency channel and updates the resource table. The updated resource table is provided to the interfering device 30.
(2) Each of the interfering devices 30 determines an application content with reference to the resource table. Here, as in the case of the first embodiment, the frequency usage status or the like of the surrounding interfering devices 30 may be considered.
(3) The interfering device 30 that has determined the application content issues the resource application toward the link-up device 34.
(4) The link-up device 34 that has received the resource application reads the resource table and refers to the availability of frequency.
(5) The link-up device 34 determines whether or not the received resource application is acceptable on the basis of the availability. Then, in a case where it is determined that the resource application is not acceptable, necessary correction is performed. Here, the frequency usage status of the interfering devices 30 disposed around the interfering device 30 that has issued the resource application may also be considered.
(6) After performing necessary correction on the resource, the link-up device 34 transmits the application to the control device 14.
(7) The control device 14 determines whether the resource application is possible and determines resource allocation on the basis of the result.
(8) When the resource allocation is determined, the control device 14 returns a response to the interfering device 30 that has issued the resource application via the link-up device 34.

Similarly to the first embodiment, the link-up device 34 in the present embodiment provides the resource table to the interfering device 30 by the routine illustrated in FIG. 9. In addition, the interfering device 30 updates its own resource table by the routine illustrated in FIG. 10. Furthermore, the interfering device 30 performs processing from resource application to radio resource change by the routine illustrated in FIG. 11. These pieces of processing are similar to those in the first embodiment, and thus duplicate description is omitted.

FIG. 13 is a flowchart for describing a flow of processing executed by the link-up device 34 for message relay and resource table update. Note that, in FIG. 13, the same steps as those illustrated in FIG. 7 are denoted by the same reference numerals, and the description thereof will be omitted or simplified.

When the resource application from the interfering device 30 is permitted in step 100, the link-up device 34 of the present embodiment determines whether the application falls within the allowable range (step 140). Specifically, here, it is determined whether the frequency channel for which the usage application has been made is available, and whether the transmission power for which the usage application has been made causes the total interference amount I to fall within the allowable range. Furthermore, in view of the situation of the surrounding interfering devices 30, it is determined whether the above is acceptable from the viewpoint of fairness.

As a result, in a case where it is determined that the resource application falls within the allowable range, the link-up device 34 advances the processing of step 102 and subsequent steps. Thus, similarly to the case of the first embodiment, update of the resource table, transmission of a response to the interfering device 30, and the like are executed.

On the other hand, when it is determined in step 140 described above that the resource application exceeds the allowable range, next, the resource application is corrected (step 142). Specifically, when the channel for which the application is made is unavailable, the channel is changed to an available channel. In addition, in a case where an excessive transmission power has been applied, the transmission power is changed to a value that causes the total interference amount I to fall within the allowable value. Furthermore, in a case where an application that impairs the overall fairness is made, a correction such as reducing the number of channels related to the application or reducing the transmission power is made.

After the above processing is finished, the processing of step 102 and subsequent steps is executed. Thus, the frequency at which the resource application for which NG is determined reaches the control device 14 can be greatly reduced. Therefore, according to the present embodiment, the communication efficiency of the entire system can be further improved as compared with the case of the first embodiment. In addition, similarly to the case of the first embodiment, fairness can be ensured for the entire carrier NW 32.

### [Modification of Second Embodiment]

Meanwhile, in the second embodiment described above, the link-up device 34 corrects both the frequency and the transmission power included in the resource application, but the present disclosure is not limited thereto. For example, in a case where only the frequency is to be corrected and the transmission power exceeds the allowable range, an NG response may be returned from the link-up device 34 to the interfering device 30 without performing correction. Alternatively, the determination in that case may be left to the control device 14, and the resource application may be provided to the control device 14 without correcting the transmission power.

In addition, in the second embodiment described above, similarly to the first embodiment, the interfering device 30 refers to the resource table and generates the resource application in consideration of the availability of the frequency. However, the present disclosure is not limited thereto. In the present embodiment, since the link-up device 34 corrects the resource application, the interfering device 30 may generate the resource application without referring to the resource table.

### Third Embodiment

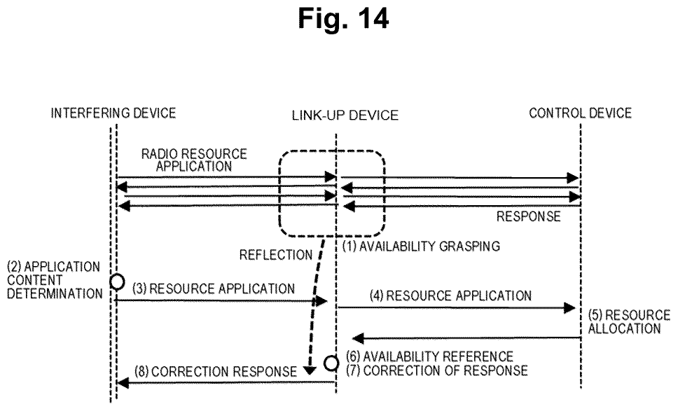

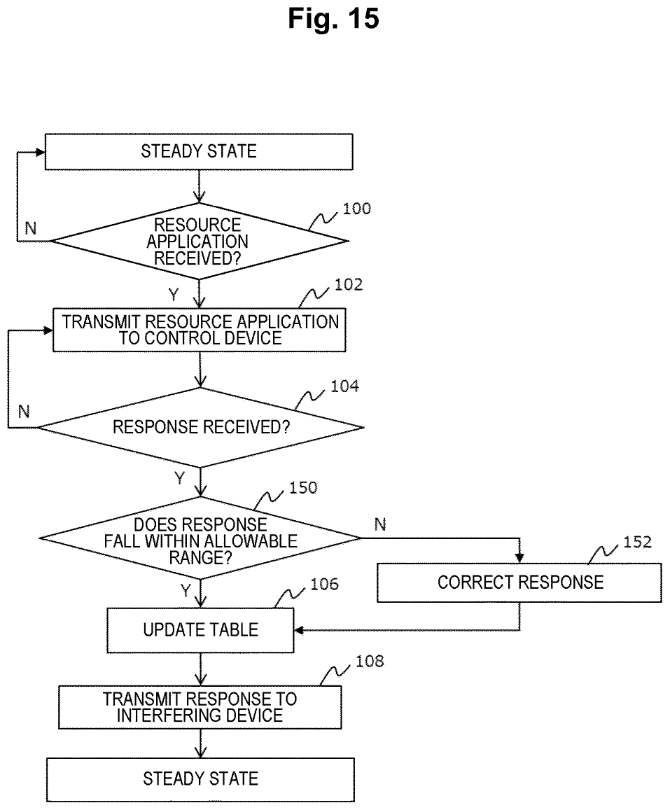

Next, the third embodiment of the present disclosure will be described with reference to FIGS. 14 and 15 together with FIGS. 2 to 5 and 9 to 11. The interference control system of the present embodiment can be implemented by the hardware configuration illustrated in FIGS. 2 to 4 as in the case of the first embodiment. In addition, the interference control system of the present embodiment implements the operation described with reference to FIG. 5 by a specific method different from the case of the first embodiment.

### [Features of Third Embodiment]

FIG. 14 is a diagram for specifically describing a flow of processing executed in the present embodiment in order to reflect the availability of frequency in the resource application and the response. FIG. 14 illustrates that the processing described below is executed in time series in the interference control system of the present embodiment.
(1) The link-up device 34 grasps the availability of the frequency channel and updates the resource table. The updated resource table is provided to the interfering device 30.
(2) Each of the interfering devices 30 determines an application content with reference to the resource table. Here, as in the case of the first embodiment, the frequency usage status or the like of the surrounding interfering devices 30 may be considered.
(3) The interfering device 30 that has determined the application content issues the resource application toward the link-up device 34.
(4) The link-up device 34 that has received the resource application transfers the resource application as it is to the control device 14.
(5) The control device 14 determines whether the resource application is possible and determines resource allocation on the basis of the result. When the resource allocation is determined, the control device 14 returns a response toward the link-up device 34.
(6) When receiving the response from the control device 14, the link-up device 34 first reads the resource table and refers to the availability of the frequency.
(7) Next the link-up device 34 determines whether or not the received response is acceptable on the basis of the availability. Here, specifically, fairness, priority, and the like of the subordinate interfering devices 30 are considered. As a result, in a case where it is determined that the fairness or the priority to be achieved is impaired, the content of the response is corrected so that the fairness or the priority is satisfied.
(8) After making necessary corrections to the response, the link-up device 34 transmits the response to the interfering device 30 that has issued the resource application.

Similarly to the first embodiment, the link-up device 34 in the present embodiment provides the resource table to the interfering device 30 by the routine illustrated in FIG. 9. In addition, the interfering device 30 updates its own resource table by the routine illustrated in FIG. 10. Furthermore, the interfering device 30 performs processing from resource application to radio resource change by the routine illustrated in FIG. 11. These pieces of processing are similar to those in the first embodiment, and thus duplicate description is omitted.

FIG. 15 is a flowchart for describing a flow of processing executed by the link-up device 34 for message relay and resource table update. Note that, in FIG. 15, the same steps as those illustrated in FIG. 7 are denoted by the same reference numerals, and the description thereof will be omitted or simplified.

When the reception of the response from the control device 14 is recognized in step 104, the link-up device 34 of the present embodiment determines whether the response falls within the allowable range (step 150). Specifically, first, it is determined whether the response from the control device 14 includes the frequency band permitted to be used and the transmission power permitted to be used. In a case where such a frequency band and transmission power are included, it is further determined whether or not there is a problem regarding fairness and priority even when the use of those resources is permitted to the interfering device 30 that has issued the resource application.

As a result, in a case where it is determined that a problem occurs in the fairness or the priority, it is determined that the response from the control device 14 does not fall within the allowable range. In this case, the link-up device 34 corrects the response to a content that does not cause a problem regarding fairness or priority (step 152). For example, the present response is corrected so as to allocate the available frequency channel to the interfering device 30 in which the use of the radio resource is excessively hindered, or to allocate the available frequency channel to the interfering device 30 in which the desired priority is not achieved. Thereafter, the link-up device 34 advances the processing of step 106 and subsequent steps. Thus, update of the resource table and return of a response to the interfering device 30 are implemented.

On the other hand, in step 150 described above, in a case where it is determined that there is no problem regarding fairness or priority even when the present response is permitted, it is determined that the response falls within the allowable range. In addition, the response indicating that there is no available resource does not cause a problem of fairness or priority, and thus is determined to fall within the allowable range. In this case, the link-up device 34 accepts the response and then immediately advances the processing of step 106 and subsequent steps.

As described above, in the present embodiment, it is possible to cause the link-up device 34 to correct the response generated by the control device 14 from the viewpoint of fairness and priority. Therefore, with the system of the present embodiment, in addition to continuing to appropriately protect the interfered device 10, appropriate fairness and priority can be given to each of the interfering devices 30 belonging to the carrier NW 32.

### [Modification of Third Embodiment]

Meanwhile, in the third embodiment described above, similarly to the first embodiment, the interfering device 30 generates the resource application in consideration of the frequency usage status of the surrounding interfering devices 30. However, the present disclosure is not limited thereto. In the present embodiment, since the link-up device 34 corrects the response, the interfering device 30 may generate the resource application without considering the surrounding frequency usage status.

### Fourth Embodiment

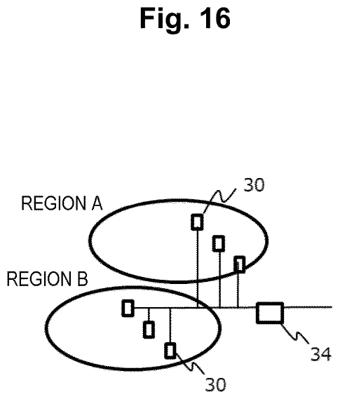

Next, the fourth embodiment of the present disclosure will be described with reference to FIGS. 16 to 20 together with FIGS. 2 to 5, 10 and 11. The interference control system of the present embodiment can be implemented by the hardware configuration illustrated in FIGS. 2 to 4 as in the case of the first embodiment. In addition, the interference control system of the present embodiment implements the operation described with reference to FIG. 5 by a specific method different from the case of the first embodiment.

### [Features of Fourth Embodiment]

FIG. 16 is a diagram for describing group division of interfering devices 30 belonging to the interference control system of the present embodiment. As illustrated in FIG. 16, in the present embodiment, the plurality of interfering devices 30 belonging to the carrier NW 32 are grouped according to the region in which they are disposed. For example, FIG. 16 illustrates a state in which three interfering devices 30 are disposed in each of the region A and the region B.

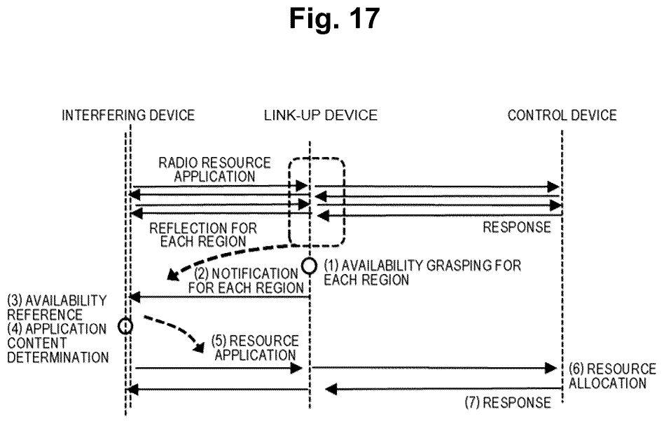

FIG. 17 is a diagram for specifically describing a flow of processing executed in the present embodiment in order to reflect the availability of frequency in the resource application and the response. FIG. 17 illustrates that the processing described below is executed in time series in the interference control system of the present embodiment.
(1) The link-up device 34 grasps the availability of the frequency channel for each region and updates the resource table for each region. The division of the region may be registered in the link-up device 34 in advance, or may be capable of being set or changed afterwards.
(2) The link-up device 34 provides a resource table updated for each region to each of the interfering devices 30. The position of the interfering device 30 is pre-registered in the control device 14. The link-up device 34 receives the provision of the information from the control device 14 and recognizes which region each of the interfering devices 30 belongs to.
(3) Each of the interfering devices 30 refers to the provided resource table and updates the held resource table.
(4) When the trigger for the application occurs, the interfering device 30 determines an application content with reference to the updated resource table. Here, the situation of other interfering devices 30 belonging to the same region may be considered.
(5) The interfering device 30 that has determined the application content transmits the resource application to the control device 14 via the link-up device 34.
(6) The control device 14 determines whether the resource application is possible and determines resource allocation on the basis of the result.
(7) When the resource allocation is determined, the control device 14 returns a response to the interfering device 30 that has issued the application via the link-up device 34.

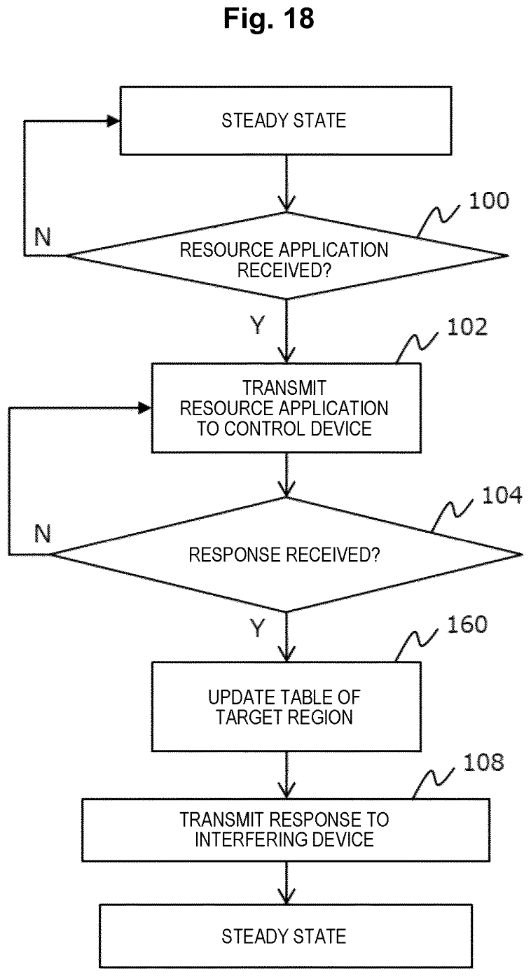

FIG. 18 is a flowchart for describing a flow of processing executed by the link-up device 34 for message relay and resource table update. Note that, in FIG. 18, the same steps as those illustrated in FIG. 7 are denoted by the same reference numerals, and the description thereof will be omitted or simplified.

As illustrated in FIG. 18, when permitting the response from the control device 14 in step 104, the link-up device 34 of the present embodiment updates the resource table of the target region (step 160).

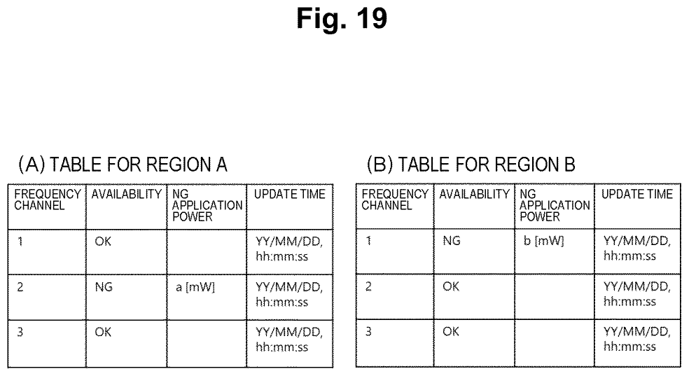

FIGS. 19(A) and 19(B) each illustrate one state of the resource table generated for each region by the link-up device 34 in the present embodiment. Specifically, FIG. 19(A) illustrates the frequency availability and the like of the region A. In addition, FIG. 19(B) illustrates the frequency availability and the like of the region B. These tables include the same information as the table illustrated in FIG. 8. In the present embodiment, a plurality of region-specific resource tables of this type is stored in the information storage unit 52 of the link-up device 34.

In step 160 described above, specifically, first, from which region the resource application that is a trigger for the response received presently is issued is specified. Next, the resource table corresponding to the region is read from the information storage unit 52. Then, the read resource table is updated on the basis of the present response. Thus, the link-up device 34 can update the resource table for each region.

Thereafter, the link-up device 34 executes the processing of step 108 and transmits a response to the interfering device 30 that has issued the resource application.

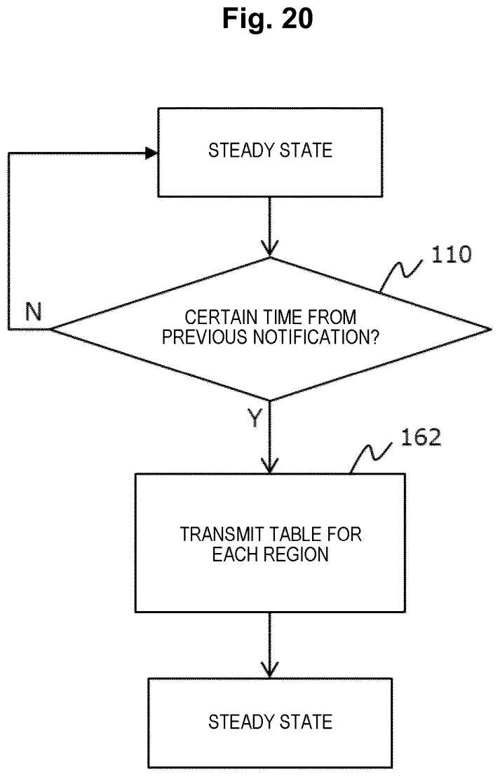

FIG. 20 is a flowchart for describing a flow of processing performed by the link-up device of the present embodiment to provide the updated resource table to the interfering device 30. Note that, in FIG. 20, the same steps as those illustrated in FIG. 9 are denoted by the same reference numerals, and the description thereof will be omitted or simplified.

As illustrated in FIG. 20, when a lapse of a certain time is recognized in step 110, the link-up device 34 of the present embodiment next transmits the resource table, which is updated for each region, for each region (step 162). Thus, the resource table of the region A is transmitted to all the interfering devices 30 belonging to the region A. Similarly, the resource table of the region to which each device belongs is transmitted to all the subordinate interfering devices 30.

In the present embodiment, the interfering device 30 updates its own resource table by the routine illustrated in FIG. 10. The interfering device 30 is provided with the resource table updated for each region as described above. Therefore, the resource table held by each of the interfering devices 30 is updated so as to indicate the status of the region to which interfering device 30 belongs. Since the other points are similar to those in the first embodiment, the description thereof is omitted here.

The interfering device 30 also performs processing from resource application to radio resource change according to the routine illustrated in FIG. 11. However, in the first embodiment, in step 132, the frequency usage status of another surrounding interfering device 30 is considered by each of the interfering devices 30, and this point is different in the present embodiment. That is, in the present embodiment, in step 132, each of the interfering devices 30 is caused to consider the status of the interfering devices 30 belonging to the same region. Since the other points are similar to those in the first embodiment, the description thereof is omitted here.

According to the above processing, it is possible to cause each of the interfering devices 30 to generate the resource application in consideration of the frequency usage status of the region to which each belongs. The interfering devices 30 disposed close to each other strongly affect each other. According to the present embodiment, it is possible to effectively avoid the occurrence of a situation in which the interfering devices 30 disposed far away from each other give unnecessary consideration to each other although they hardly affect each other. Therefore, according to the present embodiment, the communication efficiency can be further improved as compared with the case of the first to third embodiments described above.

### [Modification of Fourth Embodiment]

Meanwhile, in the configuration of the fourth embodiment described above, the technology of updating and using the resource table for each region is combined with the technology of the first embodiment described above. However, the present disclosure is not limited thereto. For example, the technology of updating and using the resource table for each region may be combined with the technology of the second embodiment described above or the technology of the third embodiment described above.

### Fifth Embodiment

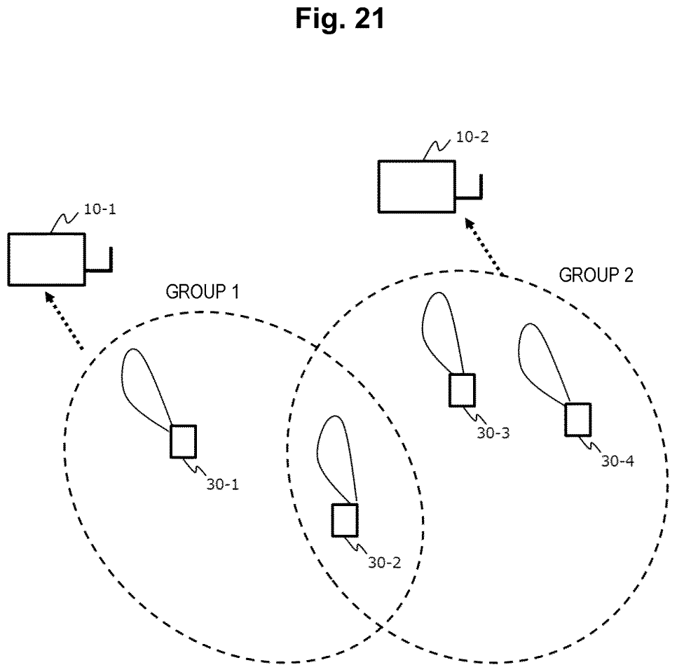

Next, the fifth embodiment of the present disclosure will be described with reference to FIGS. 21 to 26 together with FIGS. 2 to 5, 10 and 11. The interference control system of the present embodiment can be implemented by the hardware configuration illustrated in FIGS. 2 to 4 as in the case of the first embodiment. In addition, the interference control system of the present embodiment implements the operation described with reference to FIG. 5 by a specific method different from the case of the first embodiment.

### [Features of Fifth Embodiment]

FIG. 21 illustrates a state in which two interfered devices 10-1 and 10-2 and four interfering devices 30-1 to 30-4 are disposed. The interfering devices 30-1 and 30-2 are disposed at positions that affect the interfered device 10-1. In addition, the interfering devices 30-2 to 30-4 are disposed at positions that affect the interfered device 10-2. Note that the interfered devices 10-1 and 10-2 will be hereinafter simply referred to as “interfered devices 10” in a case where it is not necessary to distinguish between them.

In the present embodiment, a “group” to which each of the interfering devices 30 belongs is defined. A group of one interfering device 30 is determined on the basis of the interfered device 10 with which the interfering device 30 interferes. For example, the interfering device 30-1 affects only the interfered device 10-1. The interfered device 10-1 is affected by the interfering device 30-1 and the interfering device 30-2. In this case, the group of the interfering device 30-1 is a group including the two, that is, a group indicated as “group 1” in FIG. 21.

The interfering devices 30-3 and 30-4 each affect only the interfered device 10-2. In addition to these two devices, the interfered device 10-2 is also affected by the interfering device 30-2. In this case, both the group of the interfering device 30-3 and the group of the interfering device 30-4 are a group including the interfering devices 30-2 to 30-4, that is, a group indicated as “group 2” in FIG. 21.

On the other hand, the interfering device 30-2 affects both the interfered device 10-1 and the interfered device 10-2. Then, the interfered device 10-1 is affected by the interfering device 30-1 in addition to the interfering device 30-2. In addition, the interfered device 10-2 is affected by the interfering devices 30-3 and 30-4 in addition to the interfering device 30-2. In this case, the group of the interfering device 30-2 is a group including the four interfering devices 30-1 to 30-4, that is, a group of the combination of “group 1” and “group 2” illustrated in FIG. 21.

In determining the radio resources of the interfering device 30-1, it is sufficient to consider only the influence of the group of the interfering device 30-1, that is, the interfering devices 30 belonging to the group 1. In addition, in determining the radio resources of the interfering device 30-2, it is sufficient to consider the influence of the group of the interfering device 30-2, that is, the interfering devices 30 belonging to the sum of the group 1 and the group 2.

As described above, in an environment where there is a plurality of interfered devices 10, a combination of the interfering devices 30 to be considered in determining the radio resources to be used is different for each of the interfering devices 30. In view of such a situation, the interference control system of the present embodiment individually defines a “group” for each of the interfering devices 30 belonging to the carrier NW 32, and generates an individual resource table for the group.

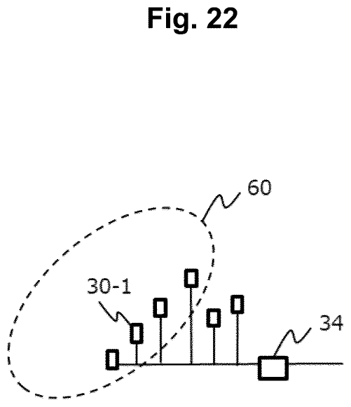

FIG. 22 illustrates a group of the interfering device 30-1 determined in the above manner. In FIG. 22, the interfering device 30-1 is assumed to affect one or a plurality of interfered devices 10, which is not illustrated. Then, an ellipse 60 indicated by the broken line in FIG. 22 represents the sum of areas that give interference to any of the one or plurality of interfered devices 10. In the present embodiment, a set of the interfering devices 30 included in such an ellipse 60 is a group of the interfering device 30-1.

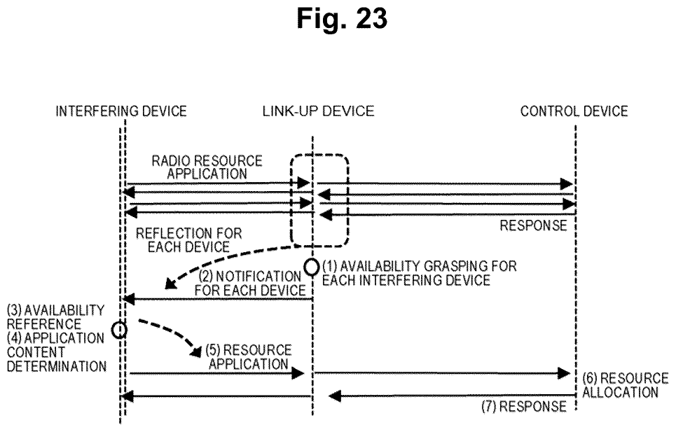

FIG. 23 is a diagram for specifically describing a flow of processing executed in the interference control system of the present embodiment. FIG. 23 specifically illustrates that the processing described below is executed in time series in the interference control system of the present embodiment.
(1) The link-up device 34 individually grasps the availability of the frequency channel for each of the interfering devices 30 and individually updates the resource table. In the individual resource table, the situation of the interfering devices 30 belonging to the group defined for each of the interfering devices 30 is reflected. The group of each of the interfering devices 30 is determined on the basis of the resource application message and the response message received by the link-up device 34.
(2) The link-up device 34 notifies each of the interfering devices 30 of the individually updated resource table.
(3) Each of the interfering devices 30 refers to the received resource table and updates its own resource table.
(4) When the trigger for the resource application occurs, the interfering device 30 determines the content of the application on the basis of the updated resource table. Here, the frequency usage status or the like of another interfering device 30 belonging to the same group may also be considered.
(5) The interfering device 30 that has determined the application content transmits the resource application to the control device 14 via the link-up device 34.
(6) The control device 14 determines whether the resource application is possible and determines resource allocation on the basis of the result.
(7) When the resource allocation is determined, the control device 14 returns a response toward the interfering device 30 that has issued the application via the link-up device 34.

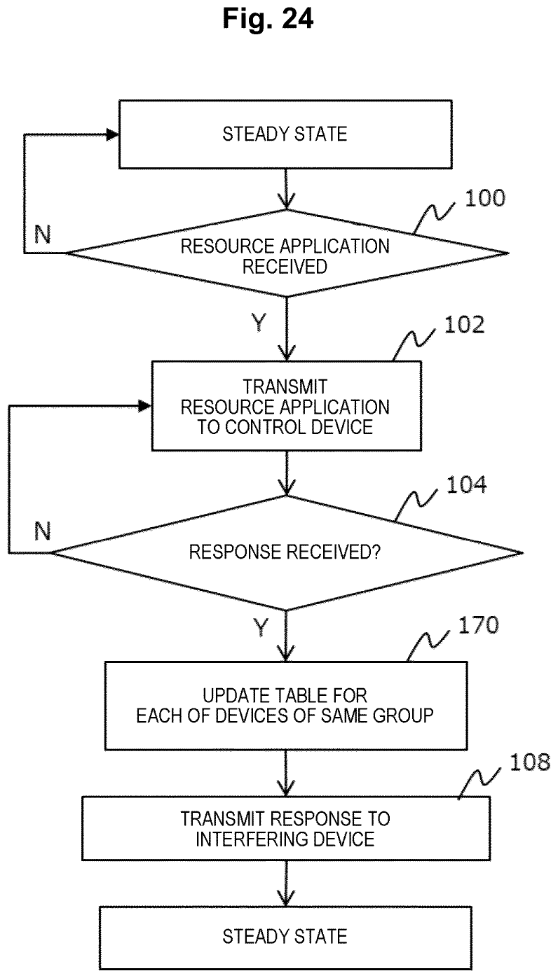

FIG. 24 is a flowchart for describing a flow of processing executed by the link-up device 34 for message relay and resource table update. Note that, in FIG. 24, the same steps as those illustrated in FIG. 7 are denoted by the same reference numerals, and the description thereof will be omitted or simplified.

As illustrated in FIG. 24, when permitting the response from the control device 14 in step 104, the link-up device 34 of the present embodiment updates the resource table of the interfering device 30 belonging to the same group as the interfering device 30 that has issued the resource application that is a trigger of the response (step 170).

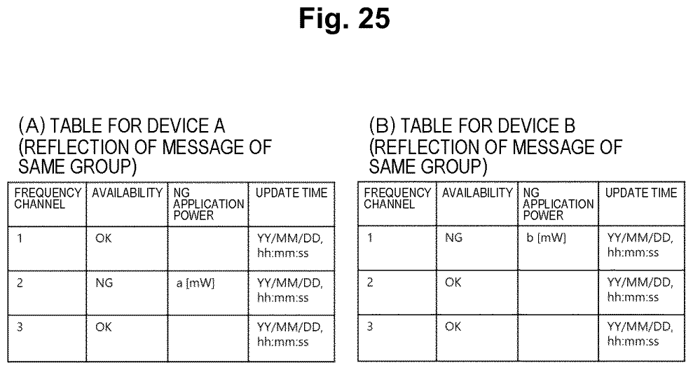

FIGS. 25(A) and 25(B) each illustrate one state of the resource table generated for each device by the link-up device 34 in the present embodiment. Specifically, FIG. 25(A) illustrates a resource table for an interfering device A. In this resource table, a message related to the interfering device 30 belonging to the same group as the device A is reflected. In addition, FIG. 25(B) illustrates a resource table for an interfering device B. In this resource table, a message related to the interfering device 30 belonging to the same group as the device B is reflected. These tables include the same information as the table illustrated in FIG. 8. In the present embodiment, the information storage unit 52 of the link-up device 34 stores the same number of device-specific resource tables as the number of subordinate interfering devices 30.

Specifically, in step 170 described above, first, the group of the interfering device 30 that has issued the resource application that is a trigger for the present response is specified. Next, an individual resource table for each of the interfering devices 30 belonging to the group is read from the information storage unit 52. Then, each of the read resource tables is updated on the basis of the present response. Thus, the link-up device 34 can update the resource table for each device.

Thereafter, the link-up device 34 executes the processing of step 108 and transmits a response to the interfering device 30 that has issued the resource application.

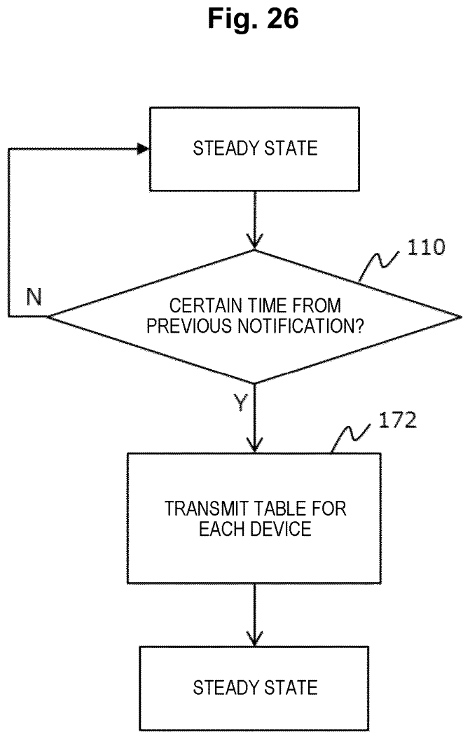

FIG. 26 is a flowchart for describing a flow of processing performed by the link-up device of the present embodiment to provide the updated resource table to the interfering device 30. Note that, in FIG. 26, the same steps as those illustrated in FIG. 9 are denoted by the same reference numerals, and the description thereof will be omitted or simplified.

As illustrated in FIG. 26, when a lapse of a certain time is recognized in step 110, the link-up device 34 of the present embodiment next transmits the resource table updated for each device toward each of the corresponding interfering devices 30 (step 172). Thus, each of the interfering devices 30 can receive the latest resource table for itself.

In the present embodiment, the interfering device 30 updates its own resource table by the routine illustrated in FIG. 10. Thus, the resource table held by each of the interfering devices 30 is updated to correctly indicate the status of all the interfering devices 30 belonging to the same group as that of the device. Since the other points are similar to those in the first embodiment, the description thereof is omitted here.

The interfering device 30 also performs processing from resource application to radio resource change according to the routine illustrated in FIG. 11. However, in the first embodiment, in step 132, the frequency usage status of another surrounding interfering device 30 is considered by each of the interfering devices 30, and this point is different in the present embodiment. That is, in the present embodiment, in step 132, each of the interfering devices 30 is caused to consider the status of the interfering devices 30 belonging to the same group. Since the other points are similar to those in the first embodiment, the description thereof is omitted here.

According to the above processing, it is possible to cause each of the interfering devices 30 to generate the resource application in consideration of the frequency usage status or the like of the interfering devices 30 belonging to the same group. That is, according to the present embodiment, it is possible to cause each of the interfering devices 30 to generate the resource application in consideration of only the influence of the interfering devices 30 that affect the same interfered device 10. Therefore, according to the present embodiment, the communication efficiency can be further improved as compared with the case of the first to fourth embodiments described above.

### [Modification of Fifth Embodiment]

Meanwhile, in the configuration of the fifth embodiment described above, the technology of updating and using the resource table for each device is combined with the technology of the first embodiment described above. However, the present disclosure is not limited thereto. For example, the technology of updating and using the resource table for each device may be combined with any technology described in the second to fourth embodiments described above.

### Sixth Embodiment

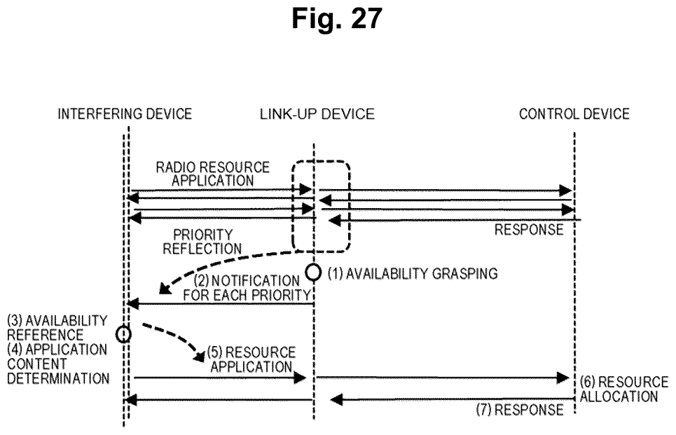

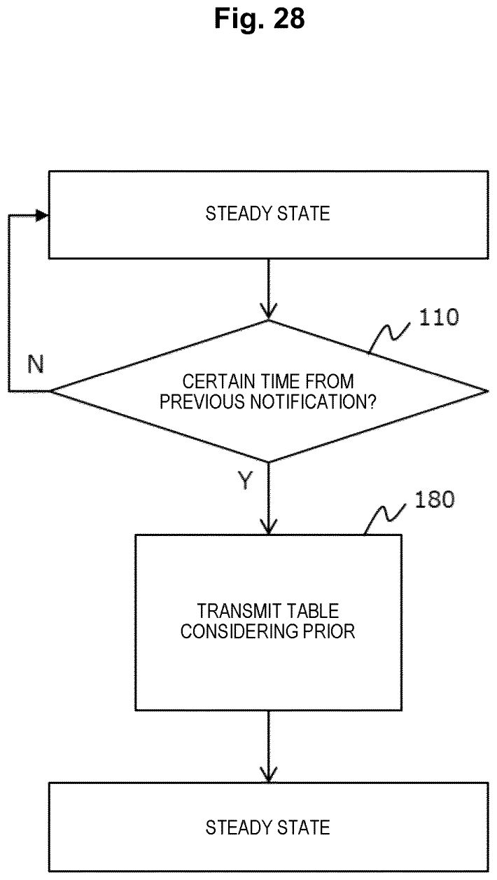

Next, the sixth embodiment of the present disclosure will be described with reference to FIGS. 27 and 28 together with FIGS. 2 to 5, 7 to 8, and 10 to 11. The interference control system of the present embodiment can be implemented by the hardware configuration illustrated in FIGS. 2 to 4 as in the case of the first embodiment. In addition, the interference control system of the present embodiment implements the operation described with reference to FIG. 5 by a specific method different from the case of the first embodiment.

### [Features of Sixth Embodiment]

FIG. 27 is a diagram for specifically describing a flow of processing executed in the present embodiment in order to reflect the availability of frequency in the resource application and the response. FIG. 27 specifically illustrates that the processing described below is executed in time series in the interference control system of the present embodiment.
(1) The link-up device 34 grasps the availability of the frequency channel.
(2) The link-up device 34 notifies the interfering device 30 of the resource table in which the priority is reflected for each priority.
(3) Each of the interfering devices 30 refers to the resource table and updates its own resource table.
(4) When the trigger for the resource application occurs, the interfering device 30 determines the application content with reference to the updated resource table. Here, as in the case of the first embodiment, the frequency usage status or the like of the surrounding interfering devices 30 may be considered.
(5) The interfering device 30 that has determined the application content transmits the resource application toward the control device 14 through the link-up device 34.
(6) The control device 14 determines whether the resource application is possible and determines resource allocation on the basis of the result.
(7) When the resource allocation is determined, the control device 14 transmits a response to the interfering device 30 that has issued the resource application via the link-up device 34.

In the present embodiment, similarly to the case of the first embodiment, the link-up device 34 reflects the content of the message in the resource table by the routine illustrated in FIG. 7. In addition, the interfering device 30 updates its own resource table by the routine illustrated in FIG. 10. Furthermore, the interfering device 30 performs processing from resource application to radio resource change by the routine illustrated in FIG. 11. These pieces of processing are similar to those in the first embodiment, and thus duplicate description is omitted.

FIG. 28 is a flowchart for describing a flow of processing executed by the link-up device 34 to notify the interfering device 30 of the resource table. Note that, in FIG. 28, the same steps as those illustrated in FIG. 9 are denoted by the same reference numerals, and the description thereof will be omitted or simplified.

When the elapse of a certain time is recognized in step 110, the link-up device 34 of the present embodiment transmits the resource table in consideration of the priority to each of the interfering devices 30 for each priority (step 180).

In the present embodiment, the priority of communication is determined in advance for each of the interfering devices 30 belonging to the carrier NW 32. Specifically, in step 180 described above, first, the priority of each interfering device 30 is read from the information storage unit 52 together with the latest resource table. Then, a plurality of priority-specific tables is generated for each priority on the basis of the resource table. For example, a certain available channel is always prepared in the table with high priority. In addition, use limitation is imposed on some channels in a table with low priority. Thereafter, the link-up device 34 transmits the priority-specific table generated in this manner to each of the interfering devices 30 to which the corresponding priority is given.

According to the above processing, it is possible to always provide an advantageous communication environment to the interfering device 30 for which a high priority is set as compared with the interfering device 30 for which a low priority is set. Therefore, with the interference control system of the present embodiment, it is possible to provide communication quality that is appropriate for the priority given in advance to each of the interfering devices 30 belonging to the carrier NW 32.

### [Modification of Sixth Embodiment]

Meanwhile, in the configuration of the sixth embodiment described above, the technology of using the resource table generated for each priority is combined with the technology of the first embodiment described above. However, the present disclosure is not limited thereto. For example, the technology of using the resource table generated for each priority may be combined with any technology described in the second to fifth embodiments described above.

### REFERENCE SIGNS LIST

10, 10-1, 10-2 Interfered device
12, 12-1 to 12-5, 30, 30-1 to 30-3 Interfering device
14 Control device
32 Carrier network (carrier NW)
34 Link-up device
36 Public network (public NW)
50 Control unit
52 Information storage unit

1. An interference control system for wireless communication, the interference control system comprising a control device that controls an interference amount given to an interfered device that performs wireless communication by a plurality of interfering devices that performs wireless communication, wherein:
a link-up device disposed between the interfering device and the control device includes a processor and a memory storing a program executed by the processor, and
the processor is configured to execute:
processing of providing a control device disposed in a public network with a resource application based on a message issued regarding use of a radio resource by an interfering device disposed in a carrier network;
processing of providing a response based on a message issued by the control device with respect to the resource application to the interfering device that has issued the resource application;
update processing of updating a resource table including information in which availability of frequency managed by the control device is estimated on a basis of the resource application and the response; and
reflection processing of reflecting the information in which the availability is estimated and included in the resource table in at least one of a subsequent resource application from the interfering device and a subsequent response to the interfering device in a form of at least one of limitation and correction.

2. The interference control system for wireless communication according to claim 1, wherein:
the reflection processing includes processing of notifying the interfering device of the information in which the availability of the frequency is estimated and included in the resource table, and
the interfering device that has received the notification reflects the availability of the frequency in generation of the resource application.

3. The interference control system for wireless communication according to claim 1, wherein the reflection processing includes at least one of processing of correcting a resource application from the interfering device on a basis of the information in which the availability of the frequency is estimated and included in the resource table and transferring the resource application to the control device and processing of correcting a response from the control device and transferring the response to the interfering device.

4. The interference control system for wireless communication according to claim 1, wherein:
the resource table is generated for each region,
the update processing includes:
processing of specifying a region to which the interfering device that has issued the resource application belongs as a target region, and
processing of updating a resource table of the target region on a basis of the resource application and the response, and
the reflection processing includes processing of reflecting information of the resource table of the target region in a resource application regarding an interfering device belonging to the target region.

5. The interference control system for wireless communication according to claim 1, wherein
the processor further executes processing of defining a group to which each of interfering devices belonging to the carrier network belongs on a basis of the resource application and the response,
a group of one interfering device is defined as a combination of all interfering devices by which one or a plurality of interfered devices with which the interfering devices interfere are affected by interference,
the resource table is individually generated so as to indicate availability of frequency in the group of the interfering devices for each of the interfering devices,
the update processing includes:
processing of specifying a group to which the interfering device that has issued the resource application belongs as a target group, and
processing of updating each of the resource tables individually generated for each of the interfering devices belonging to the target group on a basis of the resource application and the response, and
the reflection processing includes processing of reflecting information of a resource table of an interfering device regarding the resource application in the resource application.

6. An interference control method for wireless communication, the interference control method using a control device that controls an interference amount given to an interfered device that performs wireless communication by a plurality of interfering devices that performs wireless communication, the interference control method comprising:
providing a control device disposed in a public network with a resource application based on a message issued regarding use of a radio resource by an interfering device disposed in a carrier network;
providing a response based on a message issued by the control device with respect to the resource application to the interfering device that has issued the resource application;
updating a resource table including information in which availability of frequency managed by the control device is estimated on a basis of the resource application and the response; and
reflecting the information in which the availability is estimated and included in the resource table in at least one of a subsequent resource application from the interfering device and a subsequent response to the interfering device in a form of at least one of limitation and correction.

7. A link-up device for wireless communication, the link-up device using a control device that controls an interference amount given to an interfered device that performs wireless communication by a plurality of interfering devices that performs wireless communication, the link-up device comprising:
a processor; and
a memory storing a program executed by the processor,
wherein
the processor executes:
processing of providing a control device disposed in a public network with a resource application based on a message issued regarding use of a radio resource by an interfering device disposed in a carrier network;
processing of providing a response based on a message issued by the control device with respect to the resource application to the interfering device that has issued the resource application;
update processing of updating a resource table including information in which availability of frequency managed by the control device is estimated on a basis of the resource application and the response; and
reflection processing of reflecting the information in which the availability is estimated and included in the resource table in at least one of a subsequent resource application from the interfering device and a subsequent response to the interfering device in a form of at least one of limitation and correction.

8. A non-transitory computer readable medium having thereon instructions for causing the processor of the link-up device according to claim 7 to execute:
providing a control device disposed in a public network with a resource application based on a message issued regarding use of a radio resource by an interfering device disposed in a carrier network;
providing a response based on a message issued by the control device with respect to the resource application to the interfering device that has issued the resource application;
updating a resource table including information in which availability of frequency managed by the control device is estimated on a basis of the resource application and the response; and
reflecting the information in which the availability is estimated and included in the resource table in at least one of a subsequent resource application from the interfering device and a subsequent response to the interfering device in a form of at least one of limitation and correction.

9. The interference control system for wireless communication according to claim 2, wherein:
the resource table is generated for each region,
the update processing includes:
processing of specifying a region to which the interfering device that has issued the resource application belongs as a target region, and
processing of updating a resource table of the target region on a basis of the resource application and the response, and
the reflection processing includes processing of reflecting information of the resource table of the target region in a resource application regarding an interfering device belonging to the target region.

10. The interference control system for wireless communication according to claim 3, wherein:
the resource table is generated for each region,
the update processing includes:
processing of specifying a region to which the interfering device that has issued the resource application belongs as a target region, and
processing of updating a resource table of the target region on a basis of the resource application and the response, and
the reflection processing includes processing of reflecting information of the resource table of the target region in a resource application regarding an interfering device belonging to the target region.

11. The interference control system for wireless communication according to claim 2, wherein:
the processor further executes processing of defining a group to which each of interfering devices belonging to the carrier network belongs on a basis of the resource application and the response,
a group of one interfering device is defined as a combination of all interfering devices by which one or a plurality of interfered devices with which the interfering devices interfere are affected by interference,
the resource table is individually generated so as to indicate availability of frequency in the group of the interfering devices for each of the interfering devices,
the update processing includes:
processing of specifying a group to which the interfering device that has issued the resource application belongs as a target group, and
processing of updating each of the resource tables individually generated for each of the interfering devices belonging to the target group on a basis of the resource application and the response, and
the reflection processing includes processing of reflecting information of a resource table of an interfering device regarding the resource application in the resource application.

12. The interference control system for wireless communication according to claim 3, wherein:
the processor further executes processing of defining a group to which each of interfering devices belonging to the carrier network belongs on a basis of the resource application and the response,
a group of one interfering device is defined as a combination of all interfering devices by which one or a plurality of interfered devices with which the interfering devices interfere are affected by interference,
the resource table is individually generated so as to indicate availability of frequency in the group of the interfering devices for each of the interfering devices,
the update processing includes:
processing of specifying a group to which the interfering device that has issued the resource application belongs as a target group, and
processing of updating each of the resource tables individually generated for each of the interfering devices belonging to the target group on a basis of the resource application and the response, and
the reflection processing includes processing of reflecting information of a resource table of an interfering device regarding the resource application in the resource application.
